(19) United States
(12) Patent Application Publication
(10) Pub. No.: US 2018/0362251 A1
(43) Pub. Date: Dec. 20, 2018

(54) Refuse Container with Means to Secure Internal Bag Liner to Avoid Interference with Lid Opening Mechanism

(71) Applicant: David Awrey Randall, Springfield, MO (US)

(72) Inventor: David Awrey Randall, Springfield, MO (US)

(21) Appl. No.: 15/627,396

(22) Filed: Jun. 19, 2017

(51) Int. Cl. B65F 1/06; B65F 1/14

(52) U.S. Cl. CPC B65F 1/06; B65D 25/16; B65F 1/1421; B65F 1/1415

(57) ABSTRACT

An apparatus including a vessel open at the upper end to contain refuse or other material within an internal sack or bag type liner that the vessel holds open at the top. A lid that covers the opening to the vessel to conceal its contents with a lifting mechanism to open the lid in hands-free manner. A tab, flange, or other feature within the vessel to prevent the lining sack from coming into contact with and interfering with the function of the lid and its lifting mechanism.

### CROSS REFERENCE TO RELATED APPLICATIONS

This application claims the benefits of provisional patent application Ser. No. 62/406,930 filed Oct. 11, 2016.

### TECHNICAL FIELD

The present invention relates to containers, and more particularly to those for the collection of solids such as waste, trash, and or other materials.

### International Classification

### B65D 43/00; B65F 1/06; B65F 1/00; B65F 1/02

### United States Classification CPC

### B65F 1/06 (2013.01); B65F 1/10006 (2013.01); B65F 1/02 (2013.01); B65F 2001/0061 (2013.01

### Field of Classification Search

### B65F 1/06; B65F 1/062; B65F 2210/181; B65F 1/1006; B65F 1/02; B65F 1/08; B65F 2001/061; B65F 1/65

### BACKGROUND OF THE INVENTION

Containers for the collection of refuse, trash, and other articles are commonly used in home, work, and other settings. The plethora of different designs reflects the diverse needs of the materials being contained. A number of these incorporate a lid to hide the contents of the receptacle. Some use hands-free means to open or raise the lid. This offers both convenience and enhanced hygiene if the user's hands are dirty or contaminated. Most people are familiar with a foot-pedal operated trash can with a top cover that opens. Stepping on the pedal raises this lid to receive discarded materials. Releasing the foot pedal allows the lid to return to its lowered position. These are produced by a variety of manufacturers in a multitude of designs.

It is helpful for such a receptacle to have some type of lining which may be removed to facilitate cleaning and/or to contain and transfer of the contents. This also enhances hygiene and container cleanliness by separating it from dirty or contaminated materials. A trash bag or sack is commonly used as a liner to contain refuse and allows convenient transport of contents for disposal elsewhere. Unfortunately, placement of the opening of such a bag around the opening of the receptacle frequently covers and impinges upon the lifting mechanism and interferes with lid opening. Many designs have a lid that is hinged at the back and raised by an elevating vertical shaft that is also at the back. The open end/mouth of the bag often covers the vertical shaft that provides the upward force that raises the lid. It can impair the lid motion and interfere with seating the lid on the hinge such that it may fall off. This inventor has personally experienced frustration with this issue which prompted the current proposed design. Excess foot pressure is often needed to overcome excess resistance due to this and may result in the lid slamming open and even flying off the container.

### REVIEW OF PRIOR ART

References cited

| Pat. No. | Kind Code | Issue Date | Patentee |
|---|---|---|---|
| 1,097,701 | | May 1914 | Yount, G |
| 1,236,429 | | August 1917 | Hansen, A |
| 1,251,984 | | January 1918 | Losoncy, J |
| 1,461,253 | | July 1923 | Owen, O |
| 1,507,040 | | September 1924 | Zifferer, L |
| 1,515,989 | | November 1924 | Banes, W |
| 1,601,930 | | October 1926 | Suddendorf, R |
| 1,754,802 | | April 1930 | Raster, W |
| 1,820,555 | | August 1931 | Buschman, S |
| 1,828,741 | | October 1931 | LeSauvage, G |
| 1,891,651 | | December 1932 | Padelford, L |
| 1,922,729 | | August 1933 | Geibel, J |
| 1,948,413 | | February 1934 | Carola, C |
| 1,980,938 | | November 1934 | Geibel, J |
| 1,966,323 | | July 1934 | Von Elm, W |
| 2,001,445 | | May 1935 | Abele, T |
| 2,046,777 | | July 1936 | Geibel, J |
| 2,096,506 | | October 1937 | Brandstrom, C |
| 2,107,486 | | February 1937 | Wright, J |
| 2,096,578 | | October 1937 | Flanagan, W |
| 2,071,486 | | February 1937 | Wright, J |
| 2,216,279 | | October 1940 | Packer, C |
| 2,246,975 | | June 1940 | Geibel, J |
| 2,411,430 | | November 1946 | Hodson, H |
| 2,419,163 | | April 1947 | Pope, T |
| 2,435,105 | | January 1948 | Solomon, J |
| 2,456,840 | | December 1948 | Rogers, J |
| D 148,825 | | February 1948 | Snider, A |
| 2,475,125 | | July 1949 | Brownell, C |
| D 153,443 | | April 1949 | Moore, R |
| 2,532,165 | | November 1950 | Hermani, L |
| 2,563,456 | | August 1951 | Brownell, C |
| 2,551,043 | | May 1951 | Nystrom, M |
| 2,599,362 | | June 1952 | Belsky, C |
| 2,615,663 | | October 1952 | Hamilton, B |
| 2,593,455 | | April 1952 | James, G |
| D 176,083 | | November 1955 | Reinecke, J |
| 2,759,625 | | August 1956 | Ritter, J |
| 2,811,329 | | October 1957 | Press, J |
| 2,910,206 | | October 1959 | Hodgson, J |
| 2,946,474 | | July 1960 | Knapp, A |
| D 191,546 | | October 1961 | Garner, A |
| 3,008,604 | | November 1961 | Garner, A |
| 3,100,580 | | August 1963 | Smith, W |
| 3,180,384 | | April 1965 | Seifert, E |
| 3,450,297 | | June 1969 | Clerk, E |
| 3,893,649 | | July 1975 | Cornell, R |
| 4,150,764 | | April 1979 | Anderson, H |
| 4,303,174 | | December 1981 | Anderson, H |
| D 261,720 | | November 1981 | Brazis, W |
| D 288,019 | | January 1987 | Gebhard, A |
| 4,785,964 | | November 1988 | Miller, D |
| 4,865,214 | | September 1989 | Koda, W |
| 4,953,470 | | September 1990 | Koda, W |
| 4,972,966 | | November 1990 | Craft, C |
| 4,953,740 | | 1990 | Koda, W |
| 5,125,526 | | June 1992 | Sumanis, A |
| D 329,929 | | September 1992 | Knoedler, R |
| 5,147,055 | | September 1992 | Samson, J |
| 5,230,525 | | July 1993 | Delmerico, P |
| 5,213,272 | | May 1993 | Gallagher, D |
| 5,249,693 | | October 1993 | Gillispie, J |
| 5,348,222 | | September 1994 | Patey, R |
| 5,440,978 | | August 1995 | O'Brien, E |
| 5,474,201 | | December 1995 | Liu, C |
| 5,531,348 | | July 1996 | Baker, J |
| 5,535,913 | | July 1996 | Asbach, R |
| 5,671,861 | | September 1197 | Hall, K |
| 5,704,511 | | January 1998 | Kellams, K |
| 6,000,569 | | December 1999 | Liu, C |
| 6,101,204 | | January 2000 | Wang, T |
| 6,024,238 | | February 2000 | Jaros, P |
| D 435,951 | S | January 2001 | Yang, F |
| 6,345,725 | B1 | February 2002 | Lin, T |
| 6,883,676 | B2 | April 2005 | Lin, T |
| 7,395,990 | B1 | July 2008 | Stevens, G |
| 9,371,180 | B2 | June 2016 | Corbitt, L |

### Receptacles Using Bags or Sacks

Many designs allow collection of items in bags for easy transport and disposal.

Several simply keep the neck of a sack open and hold it in a position for convenient use. Some designs are mounted to the wall or inside a door, and the bag hangs from it. (Yount 1914, Seifert 1965). Others have a cylindrical (or other shape) container that secure the liner at its upper opening. (Cornell 1975, Koda 1990, Hall 1997, Corbitt 2016) The 1997 patent of Hall supports sacks with two loop type handles to the right and left sides of the container opening. (Hall, 1997) Some even have means to store multiple bags for sequential use as they become filled. (Kellams 1998, Stevens 2008) One has a dispensable sack and a method of compacting trash after it has been inserted and the lid closed. (O'Brien 1995) Another patent has means to close off the neck of the bag with a twisting motion when the lid is lowered. (Sumanis 1992)

### Solid Receptacles

A multitude of designs has been produced and/or patented. These are typically cylindrical or rectangular boxes with a bottom and an open upper end to accept materials. Some incorporate solid or sack-type inner linings while others do not. Many of these have covers and often have some type of lid-lifting mechanisms. Below is a review of these relevant patents.

### Designs Incorporating a Lid-Lifting Mechanism

A large number of different patents have been issued for receptacles incorporating a lid to hide their contents. An equally great variety of mechanisms have been used to accomplish opening of this cover. (Hansen 1917, Losoncy 1918, Owen 1923, Banes 1924, Zifferer 1924, Suddendorf 1926, Raster 1930, Buschman 1931, LeSauvage 1931, Padelford 1932, Geibel 1933, Carola 1934, Geibel 1934, Von Elm 1934, Abele 1935, Geibel 1936, Brandstrom 1937, Flanagan 1937, Wright 1937, Packer 1940, Geibel 1941, Burlin 1944, Hodson 1946, Pope 1947, Rogers 1948, Snider 1948, Solomon 1948, Brownell 1949, Moore, 1949, Hermani 1950, Brownell 1951, Nystrom 1951, Belsky 1952, Hamilton 1952, James 1952, Reinecke 1955, Ritter 1956, Press 1957, Hodgson 1959, Knapp 1960, Garner 1961 (two citations), Dyer 1965, Clerk 1969, Raftery 1976, Draggonet 1978, Dumas 1978, Anderson 1979, Anderson 1981, Brazis 1981, Kubic 1984, Gebhard 1987, Miller 1988, Koda 1989, Craft 1990, Koda 1990, Knoedler 1992, Samson 1992, Sumanis 1992, Delmerico 1993, Gallagher 1993, Gillispie 1993, Patey 1994, Liu 1995, O'Brien 1995, Asbach 1996, Kellam 1998, Liu 1999, Jaros 2000, Wang 2000, Yang 2001, Lin 2002, Lin 2005).

### Designs Incorporating an Interior Vessel or Lining to Contain Refuse

As noted above, it is unhygienic to allow contents to soil the inside of the vessel. This can result in odor, attraction of pests, and necessitate the cumbersome duty of frequently cleaning the container's interior. For this reason, many designs use a solid or sack type internal lining to contain material and separate it from the external vessel of the receptacle. (Geibel 1933, 1934, 1936, Wright 1937, Packer 1940, Geibel 1941, Hodson 1946, Solomon 1948, Hermani 1950, Belsky 1952, Hamilton 1952, Hodgson 1959, Knapp 1960, Garner 1961 (two citations), Raftery 1976, Draggonet 1978, Kubic 1984, Koda 1990, Sumanis 1992, Gallagher 1993, Patey 1994, Liu 1995, O'Brien 1995, Asbach 1996, Baker 1996, Kellam 1998, Liu 1999, Wang 2000, Lin 2002). A trash bag is often employed even when a solid internal container is present to enhance convenience for refuse disposal and avoid the need for regularly washing the inside of the internal receptacle.

### Interference of Lid-Lifting Function by Bag Liners

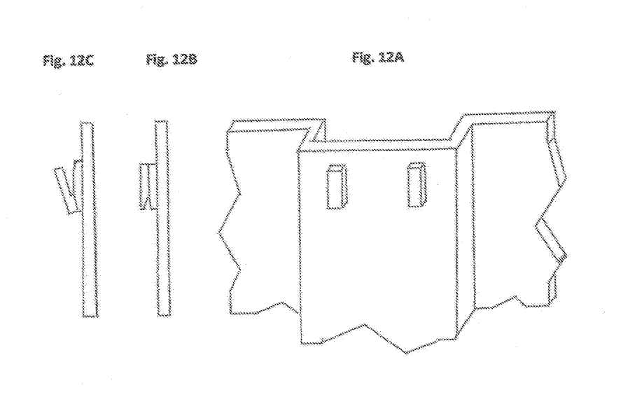

One may recognize that several of the above patents resemble commercially-available trash receptacles. (Brazis 1981, Craft 1990, Delmerico 1993) These commonly have a hinged lid attached at the back that can be removed. A foot pedal activates and elevates a vertical shaft at the rear of the vessel which exerts upward force on the undersurface of the lid which is thereby opened. A standard garbage sack is secured around the mouth of the container to stabilize the bag and prevent it from falling inward. Unfortunately, the opening to the bag is often stretched across the upper end of the shaft and interferes with contact between the shaft and the lid. This can impair lid elevation. Also, the sack may impede seating of the cover such that it will fall off of the vessel. FIG. 11 of the 1990 Craft patent actually illustrates the proximity of the mouth of the sack to the top of the vessel and potential for interference with the lid's mechanical function.

Patent Designs that Seek to Avoid Bag Interference with Lifting Mechanisms

Cornell (1975) patented a ring type device to hold the sack in place and keeping it from falling into the container. The design of Corbitt (2016) employs a ring/collar that is placed into the trash can and keeps the bag fully on the inside. Neither is germane as both lack a cover or lid lifting mechanism. Koda (1989, 1990) designed a, “wastebasket having lid hinge and actuating mechanism protector.” These incorporate a hinged flange mating to the top of the rectangular receptacle to hold the bag in position but prevent interference with a typical lid-lifting structures. Several problems occur with this approach:
(a) Manufacture requires fitting an additional, articulating mechanism to the design.
(b) Actual placement and securing of the lining sack may be cumbersome.
(c) The actuating mechanism protector is potentially fragile and at risk for breaking.

### SUMMARY OF CLAIMED INVENTION

The present invention provides a simple and easily manufactured retaining feature to prevent the mouth of a sack liner from interfering with a receptacle's lid-lifting mechanism. It incorporates a flange or other protrusion(s) inside the back of the container that pull the mouth of the bag downward and away from the area of the lifting mechanism. This can be used in receptacles of any shape. It provides a reliable, economical means to avoid the frustration of the seating and function of the cover. This invention may be used with many lid-lifting mechanisms. For this reason, the exact design of the lifting mechanism is not described as it is not germane to the bag retraction function of the present invention.

### Advantages

In comparison to previous approaches, the present design offers a number of advantages:
(a) A container with a flange or other protrusion may be manufactured easily with a variety of construction materials such as plastic or metal.
(b) It has no moving parts to complicate assembly or use.
(c) The simple design is rugged and breakage-resistant.
(d) It offers ease of use: one need only place a lining bag in a trash receptacle as normally done and then pull the back mouth of the sack below the protrusion(s).

### BRIEF DESCRIPTION OF DRAWINGS

### Legend of Parts

1. Container (vessel)
2. Vertical lid-elevating shaft
3. Foot pedal mechanism
4. Lid
5. Protrusions from back central internal wall to retract lining bag downward
6. Lining sack (bag)

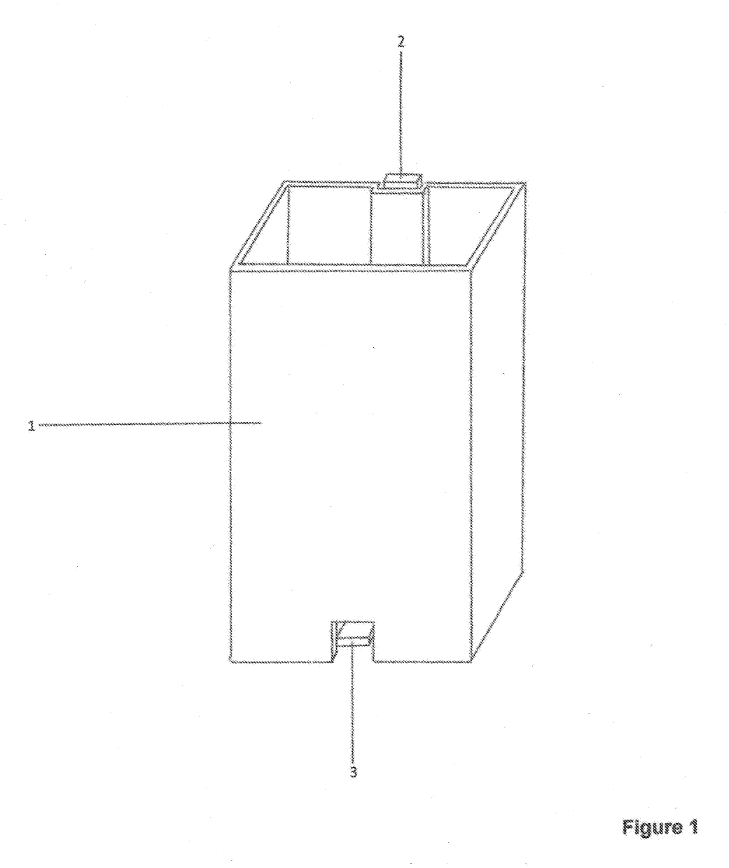

FIG. 1 is a perspective view of a refuse container showing the food pedal in the front and the vertical shaft in the back in their normal (resting) positions.

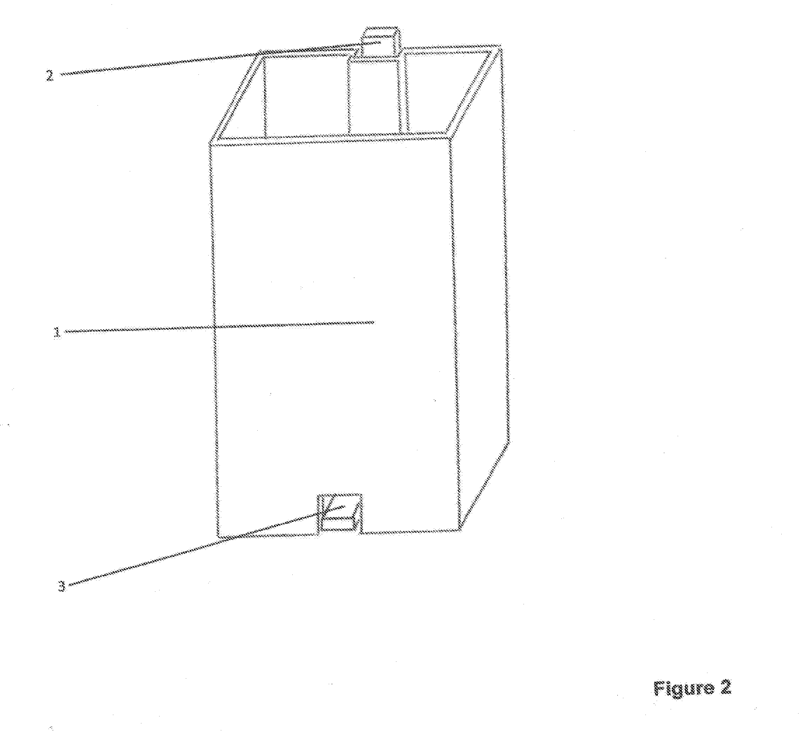

FIG. 2 is a perspective view of a container identical to that in FIG. 1 but with the foot pedal depressed and the vertical shaft raised as when raising a lid.

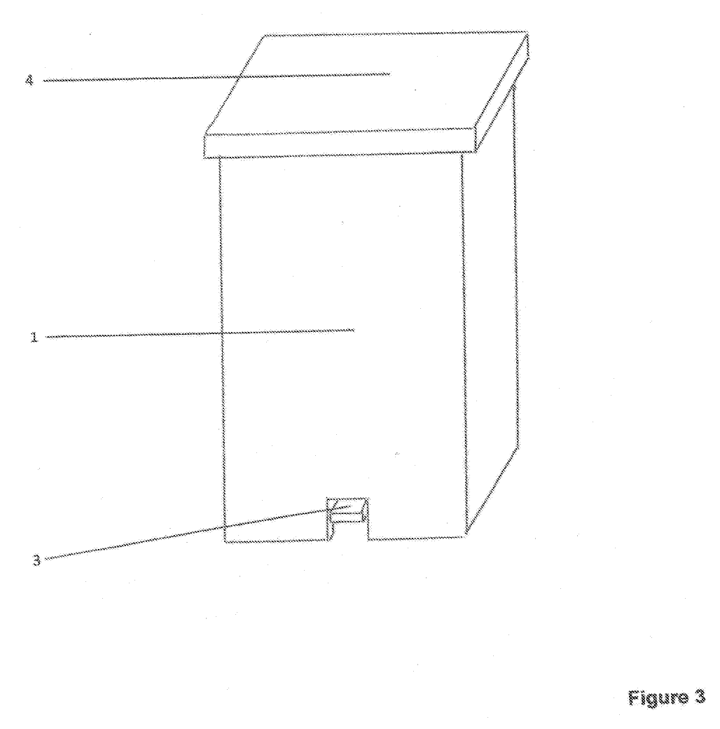

FIG. 3 is a perspective view of the same vessel as FIG. 1 with a lid fitted on top.

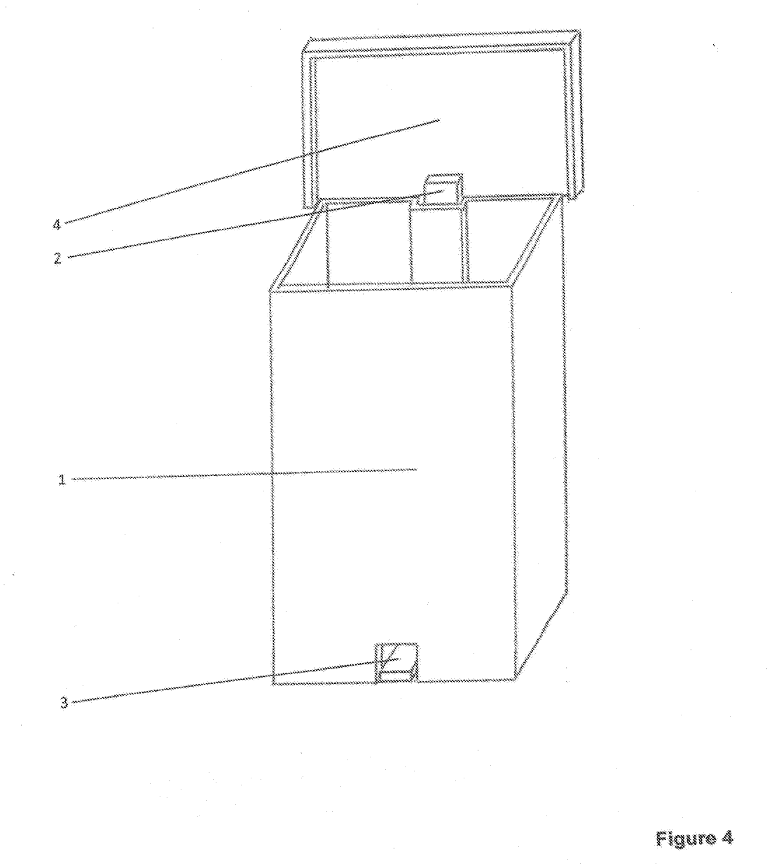

FIG. 4 is a perspective view of the same container with the lid in the raised position, the foot pedal depressed, and the vertical shaft elevated.

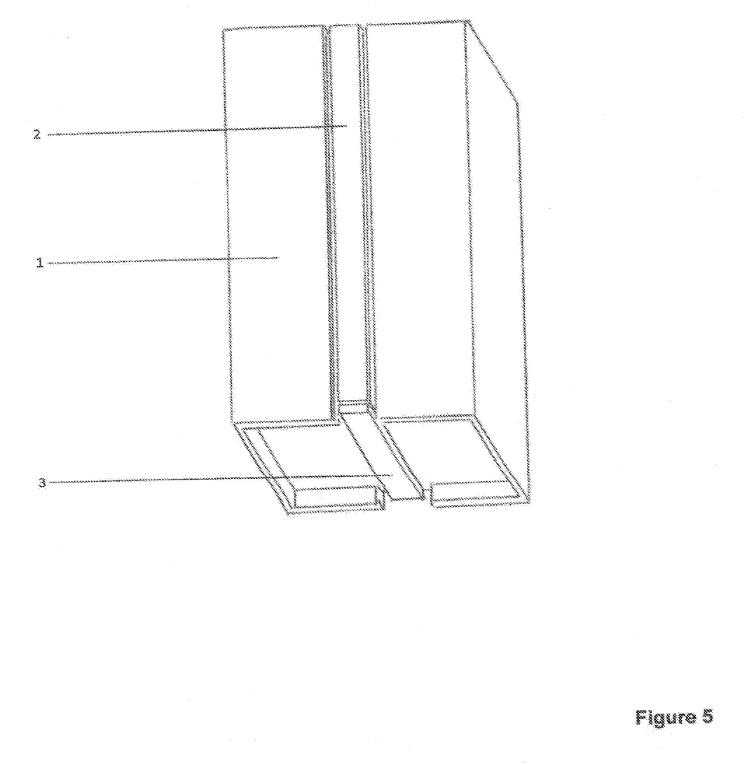

FIG. 5 is a perspective view illustrating the bottom and rear of the same container with the foot pedal mechanism under the container's bottom and the vertical shaft at the back.

FIG. 6 is a perspective view of the same container identical to FIG. 4 with the addition of two horizontal protrusions inside the central back wall of the container.

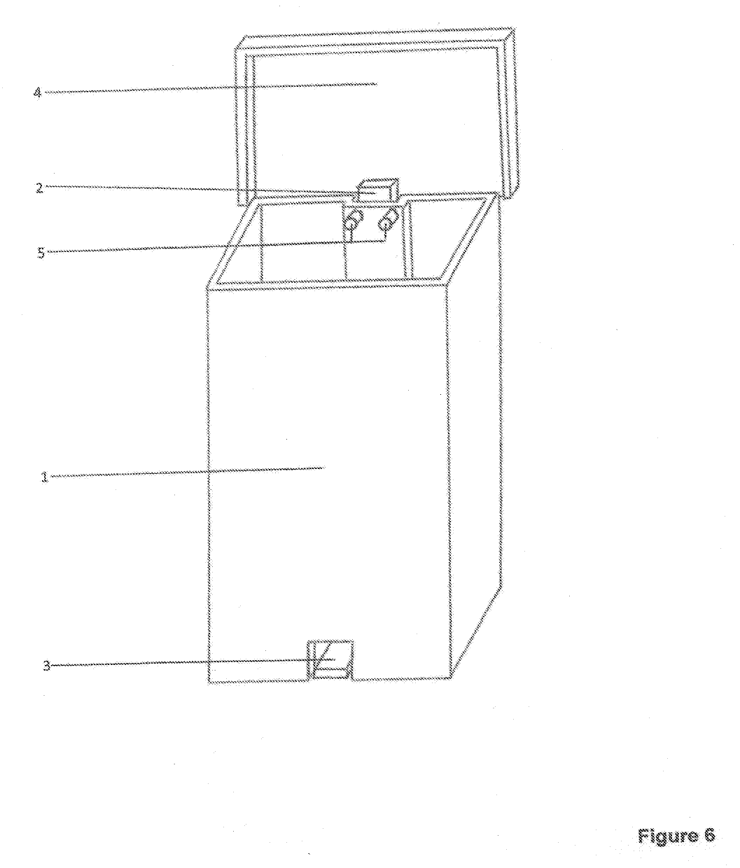

FIG. 7 is a perspective view of the same container demonstrated in FIG. 4 with a typical garbage bag/sack liner in place.

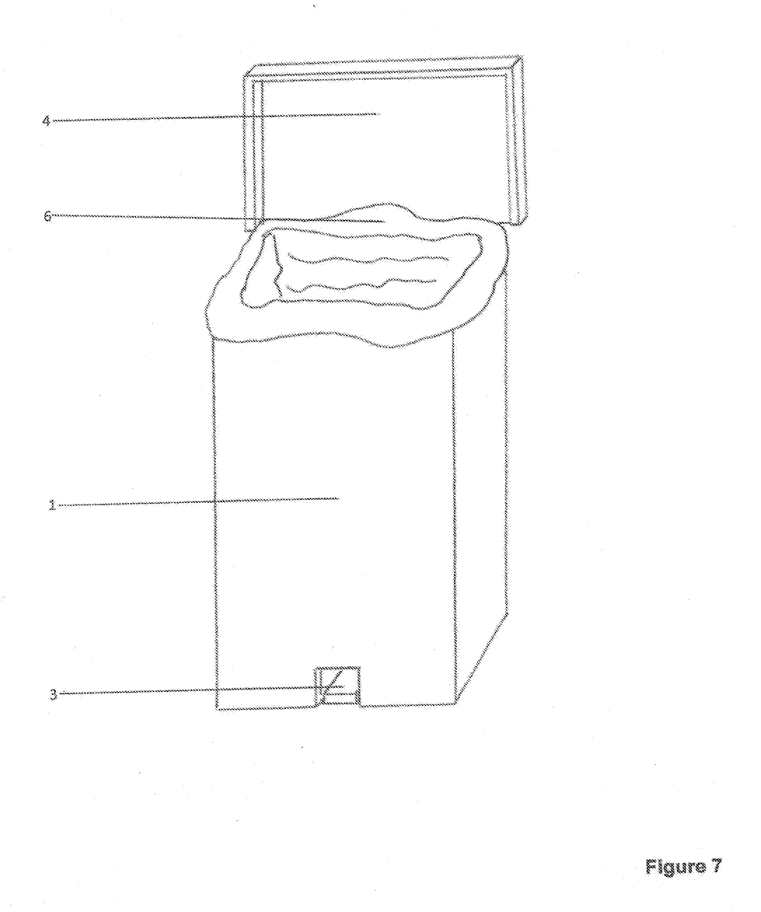

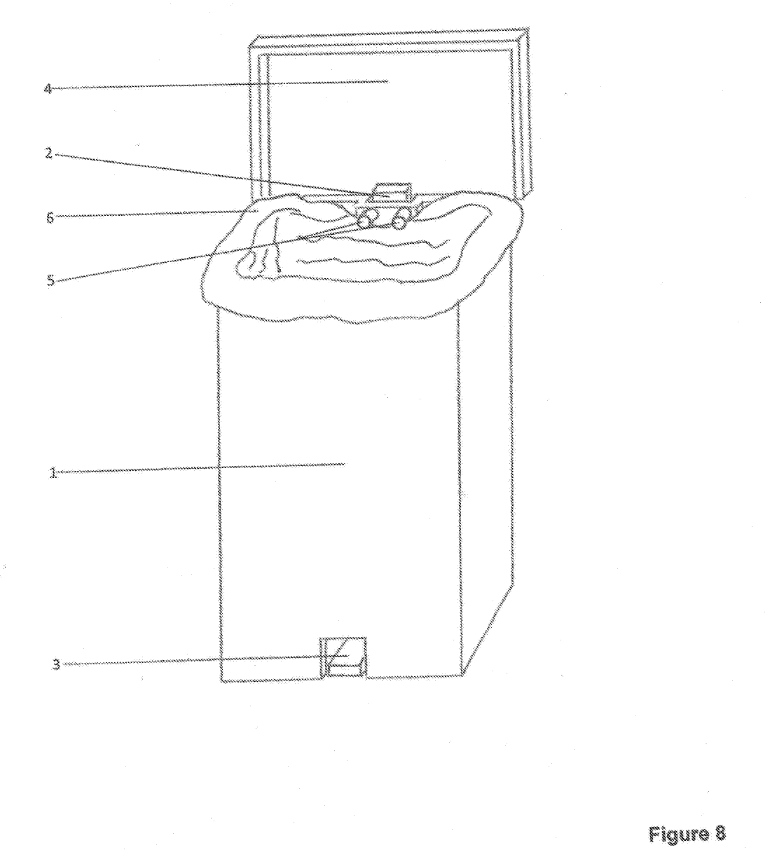

FIG. 8 is a perspective view of the same container as FIG. 6 with a garbage sack in place and protrusions pulling the bag mouth downward.

FIGS. 9A-12C illustrate identical cut-away portions of the top central back wall inside the container.

FIG. 9A is a perspective view of this area incorporating a downward L-shaped flange.

FIG. 9B shows a cross section view of the L-shaped flange and container back wall.

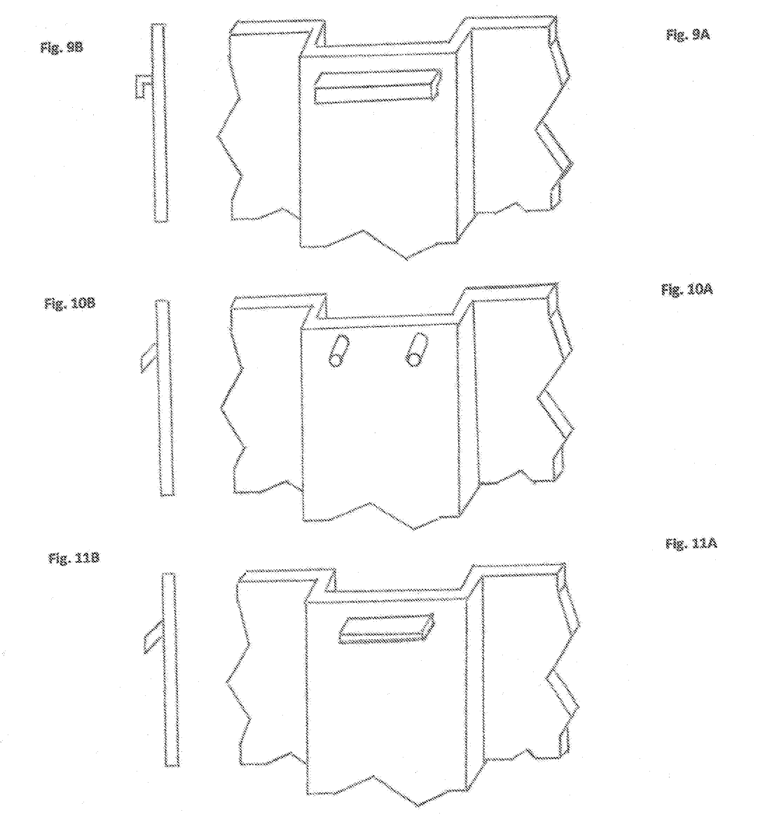

FIG. 10A is a perspective view of the same area with downward angled protrusions from the back wall.

FIG. 10B is a cross section view of the downward angled protrusions and container back wall.

FIG. 11 A is a perspective view of the same area with a downward angled flange.

FIG. 11B is a cross section view of the downward angled flange and container back wall.

FIG. 12A is a perspective view of the same area with upwardly-opening clips to secure the mouth of a lining bag.

FIG. 12B is a cross section view of the container back wall and clip in closed position.

FIG. 12C is a cross section view of the container back wall and the clip in open position.

### DETAILED DESCRIPTION OF FIRST EMBODIMENT

The following detailed description is of the best currently contemplated modes of carrying out exemplary embodiments of the invention. The description is not to be taken in a limiting sense but is made merely for the purpose of illustrating the general principles of the invention since the scope of the invention is best defined by the appended claims.

Broadly, embodiments of the present invention provide a system, a method, and apparatus for securing an internal lining sack inside a receptacle or vessel to contain refuse or other material in such a manner that the lining does not interfere with the function of its mechanical features (particularly a lid lifting mechanism). The present invention provides a simple and economic design that may be produced by existing manufacturing art already in practice for production of waste and other receptacles. Moreover, the receptacle may be produced with different shapes, dimensions, and modification of various components to accomplish the goal of positioning and holding the lining or bag. The external receptacle for trash or other material will be similar in shape and design to those commonly envisioned and produced in the past and present. It may be produced from a variety of materials.

FIG. 1 illustrates a commonly available receptacle for refuse or other items. It is comprised of a vessel (1) that is open at the top to received material being placed in it. Along the back is a vertical shaft (2) that provides upward lifting force to open a hinged lid (4). The shaft is in its down (resting) position. A foot pedal (3) is part of a lever mounted on the undersurface of the vessel such that when the pedal is pushed down, its hinged mechanism provides an upward force at the back of the vessel that elevates the vertical shaft. The foot pedal is in its up (resting) position.

FIG. 2 shows the container (1) with the posterior vertical shaft (2) in an elevated position and the foot pedal (3) depressed downward as they would be found when opening a receptacle lid.

FIG. 3 demonstrates the same receptacle (1) and foot pedal (3) as in FIGS. 1 and 2 with the addition of a typical lid on top (4). This lid is hinged at the back to allow it to open at the front to receive materials into the vessel.

FIG. 4 illustrates the same vessel (1) as in the above descriptions. Lid (4) is open and the vertical shaft (2) can be seen in the raised position to apply upward, raising force to the lid. The foot pedal (3) is in the downward position. A particular hinge mechanism for the lid is not specified as the exact hinging design is not germane to the purpose of this invention. Those familiar with the art will recognize that a multitude of hinges has been described and manufactured and may be used in receptacles of this nature.

FIG. 5 shows the rear and bottom of the vessel (1) with the foot pedal mechanism (3) and vertical shaft (2). The pedal mechanism is attached to the undersurface of the bottom of the vessel (1). The pedal and vertical shaft remain external to the vessel to protect them from the vessel contents in order to keep them clean. This external position also prevents the container contents from interfering with the motion and function of the vertical shaft and pedal/lever. A particular means of attaching the pedal mechanism has not been specified as many may be used and the specific choice is not germane to the functions and advantages of this current design.

FIG. 6 is a modification of and nearly identical to FIG. 4. It demonstrates the vessel (1), vertical shaft (2), foot pedal (3), and hinged lid (4). The foot pedal is in the down position and shaft in the elevated position. The vessel further includes two protrusions (5) from the internal back of the vessel. These are positioned beneath the site where the vertical shaft extends above the rear of the vessel. This particular design uses two short, horizontal tubular protrusions or protuberances to pull the internal sack lining (to be discussed subsequently) down and away from the lifting shaft and the shaft's articulation with the hinged lid. As discussed below, a multitude of shapes and designs of the protrusions may be substituted with equally effective downward retraction of the bag liner.

FIG. 7 shows the receptacle (1), foot pedal (3), and hinged lid (4) as discussed in a number of the above figures. A bag/sack liner (6) has been placed into the vessel as would normally be done for collection of refuse and other material. The mouth or opening of the sack is stretched or placed around the top opening of the vessel to keep the sack from falling inward and downward which could result in spillage of contents and contamination of the receptacle. The mouth of the bag covers the vertical shaft and is stretched between the shaft and lid where these structures contact each other in this illustration. This very often results in interference with the lid lifting mechanism, the hinge mechanism, and with secure attachment of the lid onto the vessel. This is a potential or actual problem in many previous and current designs. It is a commonly experienced with many of the plethora of commercially available receptacles of this nature. Some resulting problems include the lid failing to seat and fall off. Lid elevation can be impaired. The interference of the sack may increase resistance to the lifting mechanism such that when opening is accomplished, it requires enough foot pedal force that the lid opens rapidly and with enough excess force to cause it to fall off of the receptacle.

FIG. 8 is a modification of FIG. 7 by incorporating the bag-retracting protrusions (5). This illustrates the vessel (1), vertical shaft (2), foot pedal (3), hinged lid (4), protuberances (5), and bag liner (6). It can be seen that these protrusions pull the mouth of the liner downward and clear of the vertical shaft. This prevents the liner's interference with the elevating function of the shaft, the interface between the shaft and the lid (4), and also the hinge mechanism.

FIG. 9A-12C demonstrate perspective views of the same cut-away section of the internal, central rear wall of the container with some examples of the many alternative protrusions that could be used to retract the bag liner (6). Those skilled in the art will recognize that many different retracting hooks or other protrusions could be equally substituted with equally effective function.

FIG. 9A illustrates a downward-pointing L-shaped flange.

FIG. 9B shows a cross-sectional view of the flange and container back wall depicted in FIG. 9A

FIG. 10A demonstrates the perspective view with downwardly angled cylindrical protrusions

FIG. 10B is a cross sectional illustration of the vessel back wall and downwardly angled protrusions.

FIG. 11A illustrates a perspective view of the vessel back wall and a downwardly-angled tab or flange.

FIG. 11B is a cross sectional view of the downwardly angled flange and vessel back wall.

FIG. 12A shows the same perspective view of the container central back wall but incorporates upwardly shaped clips or clamps. In this example, these are similar to a commonly available clothes pin that has a hinge and spring mechanism.

FIG. 12B illustrates the cross sectional view of the vessel back and the clip in the closed position.

FIG. 12C is differs from FIG. 12B only in that the clip is in the open position, ready to receive the mouth of the bag.

### OPERATION OF THIS INVENTION

Use of this current design is very similar to use of currently available trash cans. The lid is either opened or removed. A lining sack is placed into the vessel with its open mouth extending above and wrapped around the top opening of the container. The mouth of the sack is pulled beneath the protrusions to retract it downward and clear of the lid lifting mechanism. The lid is then either replaced and/or lowered into its resting position for subsequent use.

### Additional and Alternative Embodiments

The described design can be applied to a variety of vessels of any shape. Although the above drawings and description incorporate the commonly available central rear lifting shaft, the means to prevent interference with a lifting mechanism could be positioned anywhere as necessitated by a particular placement of the lifting mechanism.

### ADVANTAGES

1. Improved convenience and use of receptacles for trash and other materials.
2. Inexpensive means to improve previous and current receptacles.
3. Absence of moving parts or more complicated features that would increase complexity of manufacture and be more susceptible to breakage.

### CONCLUSIONS, RAMIFICATIONS, AND SCOPE

The above particular descriptions provide sample embodiment example though should not be considered limiting the scope of the invention. The refuse container could exist in a multitude of shapes such as round, ovoid, or other cross sectional designs. The described retaining feature could be used with any number of lid-activating mechanisms. The scope should be determined by the appended claims and not the specifics of the above embodiments.

1. An apparatus comprising:
A vessel of metal, plastic, or other suitable material serving as a receptacle for containing refuse or other material;
A covering lid on said vessel to conceal contents;
An integral method for raising or opening the lid in a manner using any of the plurality of existing mechanisms known to those familiar with the art or potential future lifting mechanisms;
An integrated internal retaining feature to hold an internal lining such that said lining does not interfere with lid lifting other functions of the vessel;
